(19) United States
(12) Patent Application Publication
(10) Pub. No.: US 2025/0232199 A1
(43) Pub. Date: Jul. 17, 2025

(54) METHOD FOR OPERATING A QUANTUM REGISTER

(71) Applicant: Robert Bosch GmbH, Stuttgart (DE)

(72) Inventors: Johannes Selisko, Stuttgart (DE); Maximilian Amsler, Stuttgart (DE); Thomas Eckl, Leonberg (DE)

(21) Appl. No.: 18/844,584

(22) PCT Filed: Mar. 9, 2023
(86) PCT No.: PCT/EP2023/055963

§ 371 Date: Sep. 6, 2024

(30) Foreign Application Priority Data
Mar. 18, 2022 (DE) 10 2022 202 698.5

(51) Int. Cl. G06N 10/20; G06N 10/40

(52) U.S. Cl. CPC G06N 10/20; G06N 10/40

(57) ABSTRACT

A method for operating a quantum register. The method includes: carrying out of a first read-out process, so that first data representing a first state of the quantum register are ascertained; first control of the quantum register, which is in the first state, in accordance with a quantum gate; carrying out of a second read-out process, so that second data representing a second state of the quantum register which results from the first control are ascertained; adjustment of at least one parameter of the quantum gate using the first data and the second data in order to optimize a target function which is dependent on the first data and on the second data; second control of the quantum register in accordance with the quantum gate which results from the adjustment.

### FIELD

The present invention relates to methods for operating a quantum register.

### BACKGROUND INFORMATION

Current generation quantum computers (also known as noisy intermediate-scale quantum (NISQ) computers) are already being used in the fields of materials research, optimization processes and artificial intelligence, among others. One aspect of materials research is the quantitative exploration of a quantum mechanical system (hereinafter referred to briefly as QS), such as a molecule. Various methods have been developed to date to gain access to the state of a QS, some of which are explained below by way of example.

So-called exact diagonalization (ED) offers an exact mathematical solution of the QS by decomposing the complete Hilbert space of all states into eigenstates by means of matrix diagonalization, which can be combined to form the thermalized state. However, their resource requirements are growing so rapidly with the size of the QS that even modern supercomputers are rarely sufficient to obtain a solution of sufficient accuracy within a reasonable computing time. As an approximation, the so-called density matrix renormalization group (DMRG) reduces the computing time by neglecting higher energy states. Alternative algorithms are based on the quantum Monte Carlo method (QMC), which integrates over random variables. Exemplary QMC algorithms include the so-called diffusion QMC, auxiliary field QMC, continuous-time QMC, greens function QMC or Hirsch-Fey QMC. What these QMC algorithms have in common is that their convergence towards the exact solution can be improved with more computational effort, but usually only within a small parameter range (e.g., temperature range), outside of which the so-called Fermionic sign problem disrupts the convergence.

These purely classical methods have in common an exponential increase in computational effort with increasing size of the QS, which often has to be compensated for by significant compromises in terms of accuracy. These compromises are less pronounced when using a quantum computer due to its ability to leverage superposition. The capabilities of quantum computers are constantly growing. Nevertheless, so-called hybrid, i.e., quantum-classical, algorithms are used, which leave only part of the calculation to the quantum computer. Quantum-classical algorithms made it possible to leverage the advantages of both types of computers and reduce the requirements for the quantum computer, for example in terms of the number of qubits, the circuit depth, and the tolerance to errors in gate operations (the so-called noise).

Popular representatives of hybrid algorithms are the so-called variational quantum eigensolver (VQE) and the variational quantum thermalizer (VQT) based thereon. The VQE uses a variational quantum circuit to prepare a so-called ansatz state on the quantum computer. The quantum computer then measures the energy of this ansatz state. A classical (i.e., non-quantum mechanical) computer is responsible for optimizing the quantum circuit to converge the ansatz state to the ground state of the QS (i.e., at a temperature T=0 Kelvin). One aim is to calculate the state of the QS above 0 Kelvin (also referred to as thermalized or excited), which is, however, inaccessible to a VQE.

The density matrix of the thermalized state (T>0) of a QS that is mathematically described by a HamiltonianĤ can be expressed as:

$$ρ = \frac{{e}^{- β \hat{H}}}{Tr ( \text{?} )} = \frac{{\sum }_{i} {e}^{- β {E}_{i}} {ρ}_{i}}{Tr ( \text{?} )} , \qquad ( 1 )$$

$$\text{?} \text{indicates text missing or illegible when filed}$$

Here, β=1/k_{B}T denotes the inverse temperature, Tr denotes the trace, k_{B} denotes the Boltzmann constant and ρᵢ denotes the density matrix of the eigenstate of the Hamiltonian with energy Eᵢ. The state ρ is the state of the QS with which the free energy F is minimized. The free energy F as a function of the energy E and entropy S can be expressed by the following relation:

$$F = E - T \cdot S = Tr ( \hat{H} ρ ) - T \cdot Tr ( ρ ln ( ρ ) ) \qquad ( 2 )$$

One way to calculate such excited states is to first find the ground state by means of the VQE and then search for excited states by projecting the ground state out of the wave function or by assigning an additional energetic penalty term to the ground state. Both require complex quantum circuits, which make calculations difficult and error-prone. However, with the less complex so-called thermofield double state method, with which the system is enlarged and then collapsed again by a subsequent measurement, a direct measurement of entropy is not possible. To circumvent this, in turn, requires calculating the expected value of ln(ρ) on the quantum computer (for example, by means of a series expansion of the logarithm) and then measuring powers of ρ, which, however, places high demands on the quantum computer.

As a generalization of the VQE, the VQT provides access to the thermal state of a system by means of an additional machine learning (ML) algorithm that is trained for a classical probability distribution. A sample is taken from this probability distribution, which serves as the input state for the VQE. Since the quantum circuit does not change the entropy, the entropy can be calculated from the classical probability distribution. Analogous to the VQE, the variational quantum circuit is optimized and the ML algorithm is trained to minimize the free energy according to relation 2. The functionality of this VQT has already been realized by means of superconducting qubits, but requires a large number of necessary compilations of circuits and a large number of implementations of these circuits.

### SUMMARY

According to various embodiments of the present invention, a method for operating a quantum register (QR) is provided, the method comprising: carrying out of a first read-out process, so that first data representing a first state (e.g., superposition state) of the QR (e.g., its probability) (e.g., are a function thereof) are ascertained; first control of the QR, which is in the first state or in a (e.g., unentangled) state resulting therefrom, in accordance with at least one (i.e., one or more than one) quantum gate (which forms, for example, a variational quantum circuit); carrying out of a second read-out process (e.g., comprising the readout of the QR), so that second data representing a second state (e.g., superposition state) of the QR (e.g., its probability) which results from the first control (e.g., are a function thereof) are ascertained; adjustment of at least one (i.e., one or more than one) parameter of the at least one quantum gate using the first data and the second data for optimizing a target function which is dependent on the first data and on the second data; second control of the QR in accordance with the at least one quantum gate which results from the adjustment. That is, in other words, by means of adjusting at least one parameter of the at least one quantum gate, the at least one quantum gate is adjusted, in order to use the adjusted at least one quantum gate for the second control of the QR.

The method provided herein simplifies the reproducible initialization, simulation and calculation of a quantum mechanical state, for example if it is to represent a temperature of the QS above 0 Kelvin. The method described herein facilitates the efficient calculation of the free energy (e.g., according to relation (2)) by means of a quantum algorithm, for example by means of an NISQ computer or a so-called fully error corrected universal quantum computer, and the preparation of its quantum mechanical state for measurements of other variables.

For example, the method described herein can be implemented and carried out in a resource-saving and cost-efficient manner, since it does not necessarily scale exponentially with the size of the QS and requires only small resources of the quantum computer (for example, comparable to a VQE). Compared to VQT, the method described herein results in significantly lower compilation costs, allows for a better representation of the classical statistical distribution, and is simpler and more hardware-efficient to implement. This is made possible, for example, because the coupling between CPU and QPU is lower and a high tolerance to noise from the quantum computer is achieved. Put more simply, the method described herein opens up the possibilities of a VQT at a cost comparable to that of a VQE.

Various exemplary embodiments are specified below.

Exemplary embodiment 1 is a method for operating a QR as indicated above. Exemplary embodiment 2 is the method according to exemplary embodiment 1, wherein the first read-out process comprises: reading out the QR (e.g., a superposition state thereof); or reading out an additional QR (e.g., a superposition state thereof) entangled with the QR (e.g., the first state thereof and/or before the first control) (e.g., before or simultaneously with the second read-out process). The former reduces resource requirements, e.g., by requiring fewer qubits and/or a smaller circuit depth. The latter makes it possible to dispense with an intermediate measurement.

Exemplary embodiment 3 is the method according to exemplary embodiment 1 or 2, further comprising: additional first control of the QR, preferably if the QR is in an initial state, according to at least one additional quantum gate (which forms, e.g., a variational quantum circuit), wherein the first state of the QR is based on the additional control (e.g., arises directly therefrom); and wherein the adjustment preferably comprises adjusting or setting invariant at least one parameter of the at least one additional quantum gate using the first data and the second data; additional second control of the QR in accordance with the at least one additional quantum gate, which results from the adjustment. That is, in other words, by adjusting at least one parameter of the at least one additional quantum gate, the at least one additional quantum gate is adjusted, in order to use the adjusted at least one additional quantum gate for the additional second control of the QR. This makes it easier to simulate a more complex QS (e.g., a thermalized state thereof) and/or to prepare a classical probability distribution.

Exemplary embodiment 4 is the method according to exemplary embodiment 3, wherein the at least one additional quantum gate comprises fewer parameters than the at least one quantum gate; and/or wherein according to the at least one additional quantum gate fewer qubits of the QR are controlled (e.g., brought out of the initial state) than according to the at least one quantum gate. This reduces resource requirements (e.g., computing time).

Exemplary embodiment 5 is the method according to one of exemplary embodiments 1 to 4, wherein the at least one quantum gate and/or the at least one additional quantum gate are configured to entangle the QR and/or to bring it into a, preferably unentangled or at least partially entangled, superposition state (which is read out, for example, in the first and/or second read-out process). This makes it easier to simulate a more complex QS (e.g., a thermalized state thereof). The at least partially entangled superposition state can, for example, be a result of entangling the QR. For example, the set of entangled superposition states is a subset of the superposition states.

Exemplary embodiment 6 is the method according to one of exemplary embodiments 1 to 5, wherein the adjustment comprises adjusting one or more than one parameter per qubit of the QR, according to which a state of the qubit is changed when controlled. This makes it easier to obtain a more accurate calculation result.

Exemplary embodiment 7 is the method according to one of exemplary embodiments 1 to 6, wherein the first data and/or the second data represent a superposition state of the QR or a probability of a base state resulting from the superposition state (preferably by the respective read-out process). This makes it easier to simulate a more complex QS (e.g., a thermalized state thereof).

Exemplary embodiment 8 is the method according to one of exemplary embodiments 1 to 7, wherein the target function represents a physical state variable, and/or wherein the adjustment is based on an output of the target function that depends on the first data and second data and/or is minimized. This makes it easier to simulate a more complex QS (e.g., a thermalized state thereof).

Exemplary embodiment 9 is the method according to one of exemplary embodiments 1 to 8, wherein the second data are independent of the first data or are dependent on a result of the first read-out process (or the first data). This makes it easier to simulate a more complex QS or to better take into account its properties and/or to simplify/make the adjustment process more efficient. For example, the second data may depend on the first data, e.g., if the second data comprise one or more than one indication that is a function of the first data (or an indication thereof). For example, if the result of the first read-out process is that a qubit is in a state |1 [symbol] , the second read-out process can produce a different result than if the result of the first read-out process was that the qubit is in a state |0 [symbol] .

Exemplary embodiment 10 is the method according to one of exemplary embodiments 1 to 9, further comprising: ascertaining an indication of a physical variable (e.g., of a QS) based on a result of the second control and/or the additional second control, wherein the indication preferably depends on or at least differs from an output of the target function which results from the optimization. This makes it easier to evaluate physical variables (observables) in the calculated thermal state.

Exemplary embodiment 11 is a (e.g., non-quantum mechanical) control device configured to perform the method according to one of exemplary embodiments 1 to 10.

Exemplary embodiment 12 is a computer program configured to cause a (e.g., non-quantum mechanical) processor executing the computer program to perform the method according to one of exemplary embodiments 1 to 10.

Exemplary embodiment 13 is a computer-readable medium storing instructions which are configured to cause a (e.g., non-quantum mechanical) processor executing the instructions to perform the method according to one of exemplary embodiments 1 to 10. Exemplary embodiments 11 to 13 make it easier to implement the method.

In the figures, similar reference signs generally refer to the same parts throughout the various views. The figures are not necessarily true to scale, with emphasis instead generally being placed on the representation of the principles of the present invention. In the following description, various aspects are described with reference to the figures.

### BRIEF DESCRIPTION OF THE DRAWINGS

FIG. 1 shows the structure and mode of operation of a quantum processor according to various embodiments of the present invention in a schematic diagram.

FIGS. 2, 3, 6-8, and 10 in each case show a method according to various embodiments of the present invention in various schematic diagrams.

FIGS. 4A, 4B, 5, and 9 in each case show an operating sequence according to various embodiments of the present invention in various schematic diagrams.

### DETAILED DESCRIPTION OF EXAMPLE EMBODIMENTS

The following detailed description relates to the accompanying drawings, which show, by way of explanation, specific details and aspects of this disclosure in which the present invention can be executed. Other aspects may be used and structural, logical, and electrical changes may be performed without departing from the scope of protection of the present invention. The various aspects of this disclosure are not necessarily mutually exclusive, since some aspects of this disclosure may be combined with one or more other aspects of this disclosure to form new aspects.

Various examples are described in more detail below.

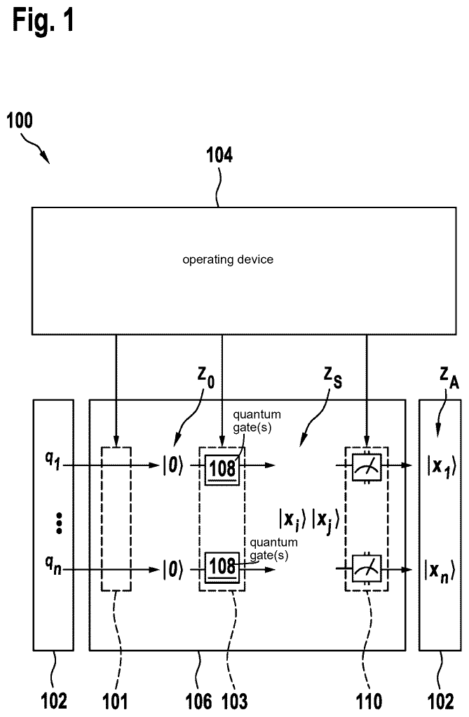

FIG. 1 illustrates the structure and mode of operation of a quantum processor (quantum process unit or briefly QPU) according to various embodiments 100 in a schematic diagram. The QPU comprises a QR 102 and an operating device 104. The term “quantum register” (QR) refers to a device by means of which a plurality of (e.g., a number of n) qubits (referred to herein, by way of example, as q₁ to qₙ) can be implemented. Exemplary components of QR 102 include: an ion trap, a plurality of (e.g., superconducting) circuit resonators, a plurality of quantum dots, a photonic system, a laser, an electromagnetic coil, etc. The operating device 104 is configured to operate (e.g., act upon) QR 102, for example according to a sequence 106 (also referred to as an operating sequence). Exemplary processes of the operating sequence 106 include: initiating 101 the QR (i.e., bringing it to an initial state Z₀), controlling 103 QR 102 and/or reading 110 QR 102. In the initial state Z₀ of QR 102, each qubit can be unentangled and/or in a base state (here, for example, |0 [symbol] ), which however does not necessarily have to be the same for all qubits.

The concrete implementation of the operating device 104 or operating sequence 106 depends on the type and architecture of the qubits. The operating device 104 can comprise one or more than one transducer configured to interact with QR 102 or its environment, e.g., to change and/or detect at least its state Z. Exemplary implementations of a transducer of the operating device include: actuator (e.g., regulating unit), sensor, transceiver, and the like. Exemplary transducers of the operating device are configured to transmit and/or detect one or more of the following to QR 102: optical radiation, a magnetic field, an electric field, electric charge, particle radiation. The QPU is a component of a quantum computer, which further comprises at least the housing environment for the QPU and the control electronics.

The term “qubit” refers to a two-state quantum system, which can be mathematically defined by two basis vectors of a two-dimensional Hilbert space (here spanned, for example, by |0 [symbol] and |1 [symbol] ). The implementation of a qubit can be of different type and different architecture. Examples of this include: energy levels in trapped ions, polarization states of photons, spins in quantum dots or silicon, and energy levels of superconducting circuit resonators.

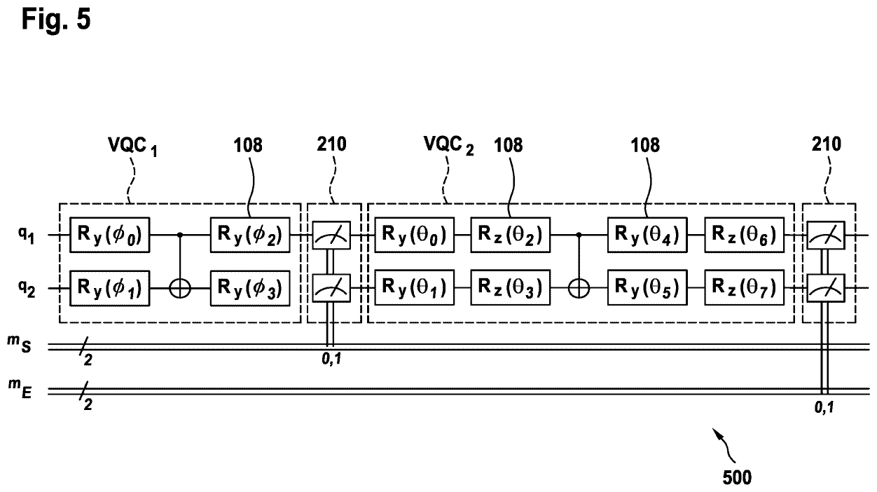

In general, the control 103 of QR 102 is configured to stimulate a change in the state (also referred to as a state change) of QR 102. The control 103 of QR 102 is performed according to one or more than one quantum gate 108 (see also FIG. 5). The term “quantum gate” (also referred to as quantum logic gate or gate) refers to the quantum mechanical analogue of a logic gate in an electrical circuit. However, the quantum gate 108 corresponds to a process of influencing QR 102, which changes the state Z of QR 102, e.g., one or more than one qubit thereof. By means of the quantum gate 108, a unitary function can be implemented in analogy to a logic gate, concretely as an analogue of its Boolean function. Mathematically, a quantum gate can be described as a unitary transformation Û, which transforms a qubit from state |x [symbol] to state Û|x [symbol] . Examples of quantum gates include: Hadamard gate, rotation gate, T-gate, controlled non-gate (CNOT), exchange node, etc. A quantum gate can be configured to form or at least maintain entanglement.

The term “quantum algorithm” (also referred to as quantum circuit) generally refers to a set of processes (e.g., quantum gates) of interaction with QR 102 or within QR 102 that, for example, trigger or at least stimulate a change in the state Z of QR 102 (e.g., of at least one qubit thereof). For the sake of clarity, a quantum circuit is written as a circuit diagram in analogy to electronics, with one axis (here from left to right) representing the chronological sequence. Analogous to an electrical circuit, the sum of a plurality of quantum circuits can in turn be regarded as a quantum circuit. From this point of view, the entire operating sequence 106, but also its components, such as the process of controlling 103 or read-out 110, can be understood as a quantum circuit. From a data processing point of view, each quantum circuit transforms one state of QR 102 (also referred to as the input state of the quantum circuit) into another state of QR 102 (also referred to as the output state of the quantum circuit). The output state of the process of the control 103 (also referred to as the control process 103) is given here, for example, as a superposition state, e.g., having |xᵢ [symbol] xⱼ [symbol] (1≤i, j≤n), but does not necessarily have to have entangled qubits. If the output state of a quantum circuit is a superposition state (e.g., having entangled qubits), the quantum circuit is also referred to herein as an ansatz circuit (or preparation circuit). In general, if related to a single qubit, the superposition state can comprise a superposition of states of the single qubit, and/or, if related to a plurality of qubits, can comprise an entanglement of the plurality of qubits and/or a superposition of their states. Accordingly, the ansatz circuit can be configured to bring a qubit into a superposition state, which does not necessarily, but can, lead to entanglement of the qubit.

The ansatz circuit is preferably configured to change the square of the absolute value of the amplitude and the phase of a qubit. A quantum circuit can optionally comprise or consist of one or more than one quantum gate (e.g., multi-qubit quantum gate) parameterized by at least one parameter (also referred to as variational parameter) (in case of an ansatz circuit also referred to as a variational circuit or briefly VQC). The ansatz circuit can optionally also comprise one or more than one unparameterized quantum gate and/or one or more than one multi-qubit quantum gate. For shortening the notation, parameterization of the quantum circuit is written vectorially herein (and is then also referred to as parameter vector) and can, but does not necessarily have to, comprise two or more parameters as components. Accordingly, the output state of the parameterized quantum circuit is a function of the parameter vector, of which each vector component is a parameter of the quantum circuit.

The process of read-out 110 of a QR 102 (also referred to as read-out process 110) comprises detecting (i.e., by means of a sensor) the state of QR 102, which can be, for example, a superposition state and/or a result of a control process 103. During read-out 110, the state of QR 102 collapses into a base state of the measurement basis of the read-out process (here, for example, u). The read-out process 110 (also referred to as quantum mechanical measurement process or briefly measurement) can, for example, be repeated multiple times for each parameter vector and/or each term of the Hamiltonian, in order to improve the accuracy of the expected value. The input state of the read-out process 110 can be the output state of the control process 103. The sensor can be part of a measuring chain which comprises a corresponding infrastructure (e.g., processor, storage medium and/or bus system or the like). The measuring chain can be configured to control the sensor, process the detected state as an input variable and, based thereon, output data that represent the input variable. The measuring chain can be implemented, for example, by means of the operating device 104. The sensor can comprise one or more than one measurement base, one measurement base being the one according to which the read-out process 110 is performed. To put it quite clearly, the measurement basis is a property of the sensor by means of which the read-out process 110 is performed. Mathematically speaking, the measurement basis spans the Hilbert space of states onto which the state of the QR is projected during read-out. Depending on the technical design, the QPU can implement one or more than one measurement basis. Optionally, the QPU can implement a plurality of measurement bases, which allows the choice of the measurement basis to be parameterized instead of and/or in addition to a parameterized quantum gate.

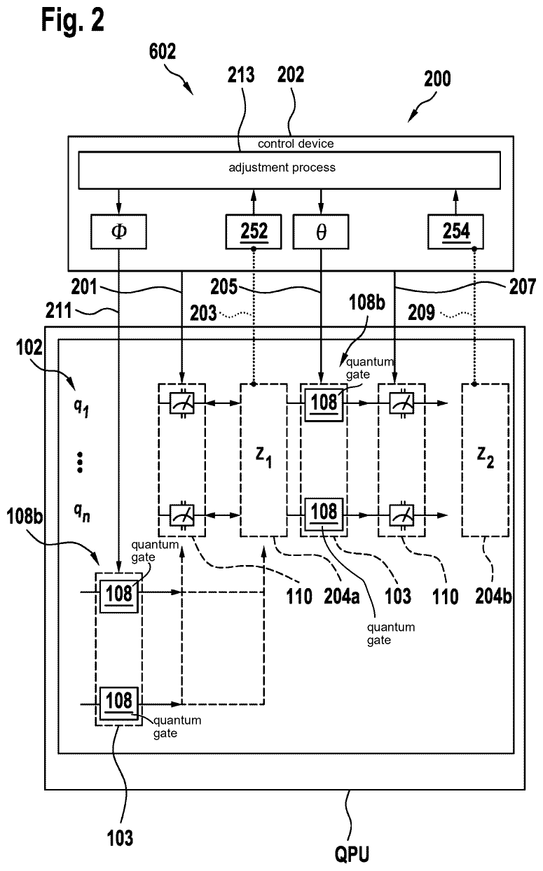

FIG. 2 illustrates a method according to various embodiments 200 in a schematic diagram, which can be carried out, for example, by a control device 202. The term “control device” may be understood as any type of entity (e.g., a processor) that allows for the processing of data or signals. The data or signals can be treated, for example, according to at least one (i.e., one or more than one) special function, which is carried out by the control device or processor. A control device, for example its processor, can comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail herein may also be understood as a processor or logic circuit. One or more of the method steps described in detail here can be executed (e.g., implemented) by one or more special functions that are carried out by the processor. The processor of the control device can, for example, be a classical (i.e., non-quantum mechanical, e.g., transistor-based) processor.

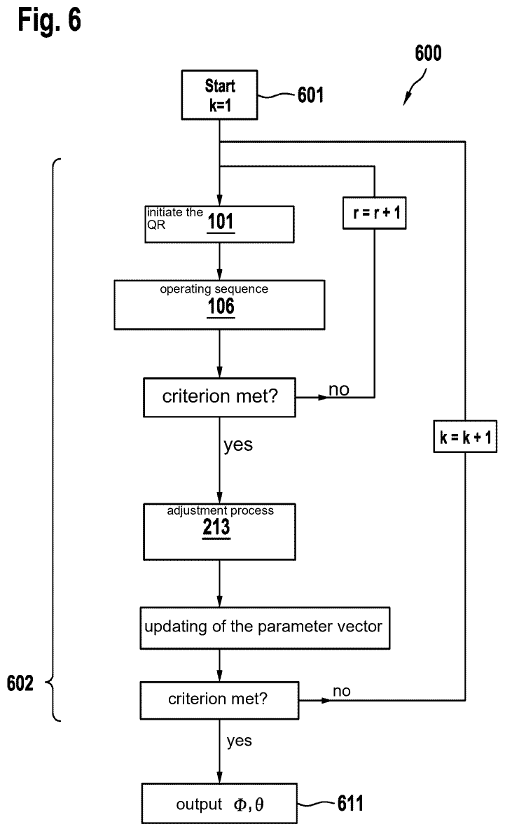

Shown is a process sequence 602 of the method (also referred to as optimization process sequence 602). The process sequence 602 comprises an operating sequence 106, which can be implemented by means of a QPU (e.g., according to embodiments 100), and (e.g., precisely) one adjustment process 213, which can be implemented by means of the control device 202, for example. The QPU comprises QR 102, which is configured to implement a plurality of qubits (here, for example, q₁ to qₙ). It can be understood that not all of the components of the adjustment process 213 necessarily have to be carried out by a classical processor, but can also, depending on the performance of the QPU, be carried out at least partially by the QPU itself. The method can optionally comprise repeating the optimization process sequence 602 multiple times (e.g., K times) (see also FIG. 6).

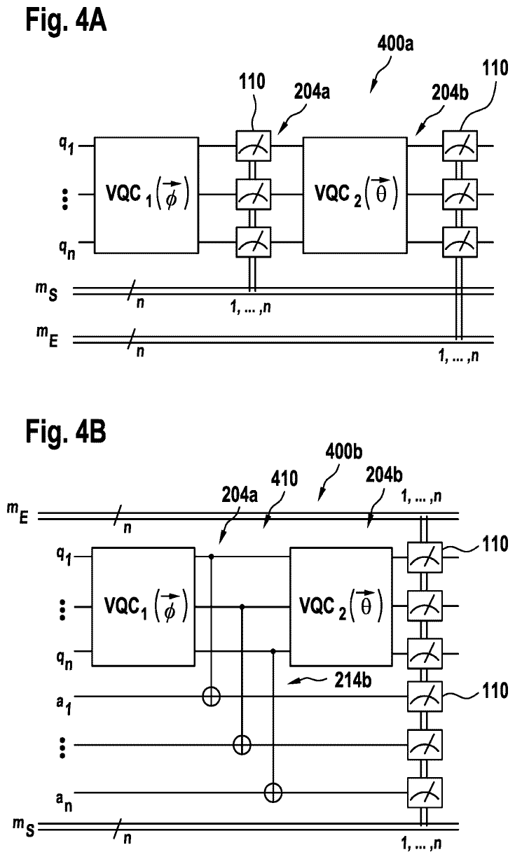

The operating sequence 106 comprises: first carrying out 201 of a read-out process 110 (also referred to as mₛ or first read-out process 201), so that first data 252 representing 203 a first state 204a (here, for example, Z₁=Z(t₁)) of QR 102 (e.g., at a first time t₁) are ascertained; a control 205 of QR 102 (also referred to as ansatz preparation 205), which is in the first state 204a; second carrying out 207 of a read-out process 110 (also referred to as m_{E} or second read-out process 207), so that second data 254 representing 209 a second state 204b resulting from the control 205 (here, for example, Z₂=Z(t₂)) of QR 102 (e.g., at a second time t₂>t₁) are ascertained. Depending on the specific implementation (see also FIGS. 4A and 4B), the first state 204a is a base state (i.e., having no superposition), e.g., if it is the output state of the first read-out process 201 or is at least based thereon; or a superposition state, e.g., if it is the output state of an additional control 211 of QR 102 (also referred to as thermalization 211) or is at least based on thermalization 211. If the operating sequence 106 comprises thermalization 211 of QR 102, preferably if it is in an initial state and/or before the first time t₁, this makes it easier to initialize the quantum mechanical state at a temperature above 0 Kelvin, since this makes use of the capabilities of the QPU. The read-out process 201 and the second read-out process 207 can, for example, be performed according to the same measurement basis of the quantum gate 108.

Ansatz preparation 205 can be performed according to a VQC (also referred to as VQC₂) which comprises one or more than one quantum gate 108 (e.g., per qubit) and/or is parameterized by means of at least one parameter (\vec{θ}) (e.g., per qubit). Thermalization 211 can be performed according to an additional VQC (also referred to as VQC₁) which has one or more than one quantum gate 108 (e.g., per qubit) and/or is parameterized by means of at least one parameter (\vec{ϕ}) (e.g., per qubit). It can be understood that what has been described with respect to the quantum gate 108 can also apply by analogy to more than one quantum gate per VQC.

For each optimization process sequence 602, (e.g., exactly), one adjustment 213 of the parameter vector (\vec{ϕ}, \vec{θ}) of the optimization process sequence 602 (also referred to as adjustment process) can be performed using the first data 252 and the second data 254, wherein the parameter vector (\vec{ϕ}, \vec{θ}) comprises at least one parameter of VQC₁ and/or VQC₂. Each optimization process sequence 602 can optionally comprise carrying out the operating sequence 106 multiple times, for example per adjustment process 213 (see also FIG. 6), e.g., without changing the parameter vector used (\vec{ϕ}, \vec{θ}) and/or to obtain statistics for the first data 252 and second data 254. The adjustment process 213 can, for example, be performed in such a way that a target function that depends on the first data and second data is optimized, e.g., that its output is minimized. The target function (e.g., its output) can, for example, represent a QS, e.g., a state variable thereof, which will be explained in more detail below.

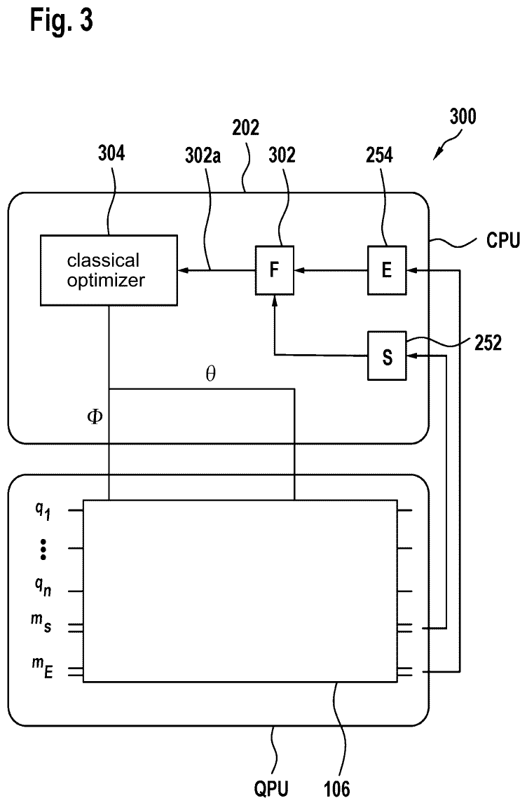

FIG. 3 illustrates the method according to various embodiments 300 in a schematic diagram, which can be carried out for example by means of a control device 202, here, for example, designed as a CPU, for example based on a variation principle (e.g., the Rayleigh-Ritz principle). Embodiments 300 can be configured as embodiments 200, wherein the output 302a of the target function 302 can represent, for example, a state variable (e.g., the free energy F) of a thermalized QS, preferably as a function of the entropy S and the energy E of the thermalized QS, further preferably according to relation (2). The first data 252 then clearly represent the entropy and the second data 254 represent the energy of the thermalized QS, which were ascertained based on the measured values of the QPU. What is described here merely as an example of the free energy (e.g., as output of the target function) can apply by analogy to any other state variable of a (e.g., thermalized) QS.

The optimization of the target function 302 can be performed by means of a so-called optimization algorithm 304, which is configured to calculate the parameter vector (\vec{ϕ}, \vec{θ}) of the operating sequence 106 or at least its change based on the output 302a of the target function 302, for example under the constraint of minimizing the output 302a of the target function 302 (for example, by treating it as a cost function), for example based on the history of the parameter vector (\vec{ϕ}, \vec{θ}) and/or the history of the output 302a of the target function 302. This allows for optimization of the parameters of each VQC of the operating sequence 106. In one working example, the input of the operating sequence 106 comprises a molecular Hamiltonian and a parameter vector (\vec{ϕ}, \vec{θ}) for one or more than one VQC, according to which the state of QR 102 is prepared to simulate the quantum state of the molecule. In the or another working example, the optimization algorithm 304 is configured to evaluate the target function 302 as a cost function and to calculate its gradient at each run of the optimization process sequence 602. Exemplary implementations of the optimization algorithm 304 include: the so-called constrained optimization by linear approximation (COBYLA); conjugant gradient or quasi-Newton optimizer, which can be found, for example, in the Python packages qiskit or scipy.

The optimization process sequence 602 can comprise transforming its actual parameter vector (\vec{ϕ}, \vec{θ}) and the output of the target function 302 into new values for the parameter vector (\vec{ϕ}, \vec{θ}) by means of the optimization algorithm 304. These new values are used as the actual parameter vector (\vec{ϕ}, \vec{θ}) of the subsequent optimization process sequence 602 to control QR 102. With each carrying out of the optimization process sequence 602 (then also referred to as iteration), the parameter vector (\vec{ϕ}, \vec{θ}) converges to a vector representing the thermal state of the QS. This process can be repeated until the output of the target function 302 converges to a minimum or until a convergence criterion is met.

FIGS. 4A and 4B in each case illustrate an operating sequence 106 according to various embodiments 400a, 400b in a schematic diagram, which can be implemented, for example, in embodiments 100 to 300, and which have in common that the operating sequence 106 (then also referred to as full quantum variational thermalizer or briefly FQVT) comprises two process pairs, each of which process pairs comprises a VQC (VQC₁ or VQC₂) and a subsequent read-out process 110. The VQC of each process pair is configured to provide a superposition (also referred to as superposition state) of a plurality of quantum states with different amplitudes as the output state (state of the qubits). The read-out process 110 of each process pair can act on a superposition and be configured to convert superposition into a base state.

VQC₁ and VQC₂ can be executed one after the other. VQC₁ depends on a first parameter vector \vec{ϕ}. Exemplary implementations of VQC₁ include: unitary-coupled cluster-singles-doubles (UCCSD) or the so-called efficient SU2 (spatial unitary group of rank 2). Based on a thermalized QS, VQC₁ generates classical states with probabilities pᵢ=exp(−βEᵢ) and, based thereon, VQC₂ generates the corresponding eigenstates ψ₁ of the Hamiltonian. VQC₂ depends on a second parameter vector \vec{θ}. Embodiments 400a, 400b further have in common that the second read-out process (m_{E}) comprises detecting (measuring) the output state of VQC₂. The output state of VQC₂ can be transformed into the energy state, which represents the energy of the second state 204b, by means of the measurement m_{E}.

According to embodiments 400a, the first read-out process (mₛ) comprises detecting (measuring) the output state of VQC₁, i.e., reading out QR 102 according to VQC₁ after controlling. The output state of VQC₁ can be transformed into a base state with a probability p (given by the amplitude of that base state) by means of the measurement mₛ. FQVT 106 can be executed multiple times per optimization process sequence 602, wherein statistics on the output of the measurements mₛ is collected. After a frequent repetition of FQVT 106, the probability ρᵢ of obtaining the base state i from the measurement mₛ in a new run can be ascertained from measurement mₛ. The entropy of a quantum mechanical system can be ascertained based on probabilities ρᵢ, for example according to the following relation:

$$S = {\sum }_{i} {p}_{i} ln ( {p}_{i} ) .$$

The operating sequence 106 according to embodiments 400a further comprises transforming the output state of the first read-out process mₛ into a superposition as a second state 204b by means of VQC₂.

If the QPU is not able to perform a read-out process 110 between two VQCs (also referred to as an intermediate measurement), or if no intermediate measurement is to be performed for other reasons, the operating sequence 106 according to embodiments 400b can be used. According to embodiments 400b, the available qubits comprise a plurality of groups, a first group of qubits (also referred to as a main logical register) and a second group of qubits (also referred to as an auxiliary logical register or ancilla qubits) of which are configured to be entangled with one another. The main register (q₁ to qₙ) and the auxiliary register (here a₁ to aₙ) are treated herein as (logically) separate QR 102 for ease of understanding, although it can be understood that they may, but do not necessarily have to, be part of the same (physical) QR 102. The auxiliary register comprises at least as many qubits as the main register, e.g., a number of n qubits.

According to embodiments 400b, only the main register is controlled according to VQC₁ and VQC₂ and read out by means of m_{E}. The operating sequence 106 according to embodiments 400b further comprises entangling the output state of VQC₁ (which is, for example, a superposition state) with the auxiliary register 410 (also referred to as entanglement process 410). The entanglement process 410 can comprise entangling each qubit of the main register with (e.g., exactly) one qubit of the auxiliary register, for example, by means of at least one controlled-not-gate. The output of the entanglement process 410 comprises a plurality of (e.g., a number of n) pairs of entangled qubits, each pair comprising one qubit of the main register and one qubit of the auxiliary register.

The operating sequence 106 according to embodiments 400b further comprises transforming (e.g., only) the state of the main register (which is e.g., a superposition state), resulting from the entanglement process 410, into superposition as the second state 204b by means of VQC₂. The first read-out process mₛ then comprises detecting (measuring) the state 214b of the auxiliary register resulting from the entanglement process 410. The state 214b of the auxiliary register can be transformed into the base state with a probability p (given by the amplitude of that base state) by means of the measurement mₛ. The (e.g., joint) measurement of all qubits at the end of the operating sequence 106 then clearly provides the energy (measurement of qᵢ) and entropy (measurement of aᵢ). In one example, the first read-out process mₛ (of the auxiliary register) is performed (temporally), e.g., immediately, before the second read-out process m_{E} or simultaneously with the second read-out process m_{E} or, e.g., immediately, after the second read-out process m_{E}.

FIG. 5 illustrates an operating sequence 106 according to various embodiments 500 in a schematic diagram showing an exemplary implementation of embodiments 400a in case of two qubits. Rₜ(θⱼ) denotes a rotation about the t-axis (t=x, y or z) depending on θⱼ, which indicates, for example, the angle of rotation. The index of ϕᵢ or θⱼ (i, j ∈ [symbol] ) references the components of the parameter vector (\vec{ϕ}, \vec{θ}). It can be understood that the same may apply by analogy to embodiments 400b.

In one working example, in case of two qubits, the Hamiltonian can be formulated as follows:

$$\hat{H} = - ( {n}_{0} + {n}_{1} ) + 2 {n}_{0} {n}_{1} + 0.5 ( {c}_{0}^{†} {c}_{1} + {c}_{1}^{†} {c}_{0} )$$

wherein c^{†} denotes the creation operator, c the annihilation operator and n the occupation number operator. The index of the respective operator indicates the qubit on which it acts.

FIG. 6 illustrates the method according to various embodiments 600 in a schematic diagram, based on which additional exemplary implementations of embodiments 100 to 500 are explained. The method can optionally comprise repeating the optimization process sequence 602 multiple times (e.g., K times) until a criterion is met, for example, until a number k of runs (also referred to as a run counter) reaches a target number K or a change in the output of the target function falls below a threshold. If the criterion is met, the parameter vector updated in the last optimization process sequence 602 (\vec{ϕ}, \vec{θ})=(\vec{ϕ}, \vec{θ})ₒᵤₜₚᵤₜ (also referred to as output vector), e.g., (\vec{ϕ}, \vec{θ})_{k=K}=(\vec{ϕ}, \vec{θ})ₒᵤₜₚᵤₜ, can be output 611.

The or each optimization process sequence 602 can comprise updating the parameter vector (\vec{ϕ}, \vec{θ}) based on the result of the adjustment process 213. A VQC (e.g., VQC₁ and/or VQC₂) of the k-th (2≤k≤K) optimization process sequence uses the parameter vector (\vec{ϕ}, \vec{θ})ₖ₋₁ which the previously carried out (k−1)-th optimization process sequence 602 has output in an updated manner. Accordingly, in the k-th optimization process sequence 602, a control of the QR 102 according to VQC₁ and/or VQC₂ is performed, which result from the adjustment process 213 of the (k−1)-th optimization process sequence.

Optionally, the or each optimization process sequence 602 can comprise executing the operating sequence 106 multiple times, for example until a criterion is met, for example if a number r of runs reaches a target number R. The adjustment process 213 can then be based on the first data and second data from a plurality of operating sequences 106. The method can optionally comprise, at the beginning of the optimization process sequence 602, in 601, to initialize the parameter vector (\vec{ϕ}, \vec{θ}), i.e., to define its initial values. The initial values of the parameter vector (\vec{ϕ}, \vec{θ}) can be ascertained, for example, by means of a random generator or read out from a memory of the control device 202.

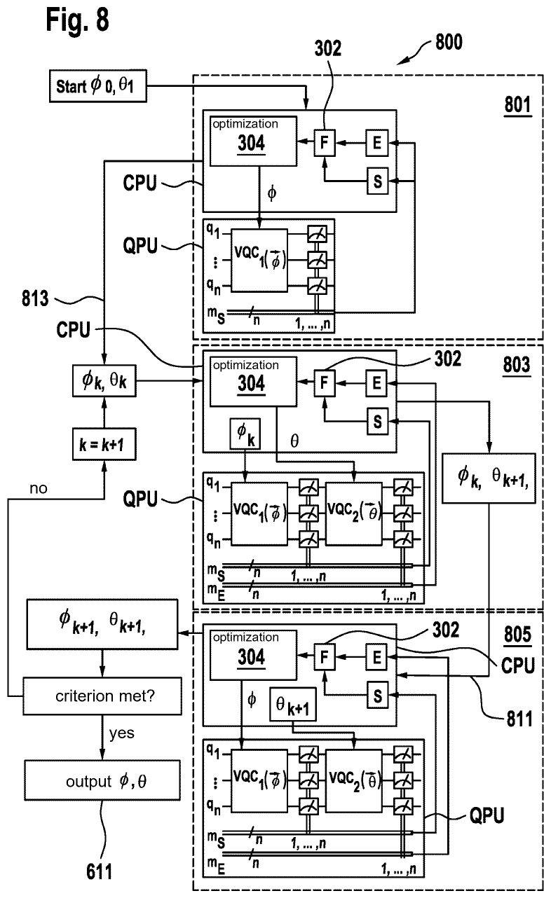

In a first exemplary implementation (illustratively a segmented optimization), the method (e.g., for optimizing the free energy) comprises a plurality of stages, in each stage of which one or more than one optimization process sequence 602 is carried out. For this purpose, see FIG. 8, which illustrates the first exemplary implementation in a schematic diagram 800 analogous to embodiments 600. In the first stage 801 of the plurality of stages (illustratively a VQC₁ optimization with simplified Hamiltonian), the operating sequence 106 comprises only VQC₁, parameterized by means of the parameter vector \vec{ϕ}, and the first read-out process mₛ. An entropy can be ascertained from the distribution of the measured values. The energy value can be ascertained by means of the same measurement mₛ. A simplification of the Hamiltonian (also referred to as model Hamiltonian) is used, which is diagonally in the basis used for the measurement mₛ. Examples of such a model Hamiltonian include: the so-called atomic limit of the Hamiltonian, with which all hopping terms are set to zero, or a Hamiltonian that assigns each measurement the value of its bit string. The result of the first stage can be improved by ensuring that the model Hamiltonian comprises as few degeneracies as possible, or that its degeneracies also occur in the real physical QS. In the second stage 803 of the plurality of stages (illustratively a VQC₂ optimization with constant probability distribution), the operating sequence 106 comprises the two process pairs, wherein the parameter vector \vec{ϕ} output by the first stage is adopted 813 and set invariant. Minimizing the free energy now yields the parameter vector \vec{θ}, which maps the input states to the correct eigenstates of the physical Hamiltonian. In the third stage 805 of the plurality of stages (illustratively a VQC₁ optimization with real Hamiltonian), the parameter vector \vec{θ}ₒᵤₜₚᵤₜ by the second stage is adopted 811 and kept invariant. Minimizing the free energy with real Hamiltonian now yields the parameter vector, which assigns the corresponding probabilities to the eigenstates of the Hamiltonian. If necessary, the second and/or third stages can be repeated. This increases the accuracy of the result because the probability distribution determines the accuracy with which the eigenstates are determined. The first exemplary implementation reduces resource requirements and the error susceptibility of the method, since optimization with fewer parameters is significantly faster and converges less frequently to local minima instead of finding the global minimum.

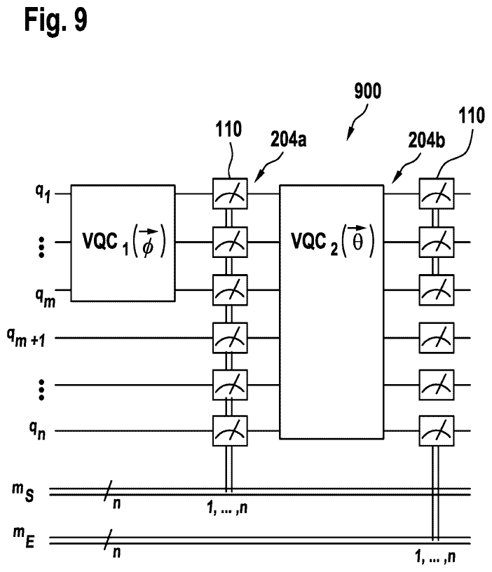

In a second exemplary implementation (illustratively approximate FQVT), the method comprises reducing VQC₁ and not changing all qubits variationally. For this purpose, see FIG. 9, which illustrates the first exemplary implementation in a schematic diagram 900 analogous to embodiments 400a. In other words: VQC₁ is configured to change only part of QR 102 and/or to change fewer qubits than VQC₂. This has the result that a smaller number of states remain after the entropy measurement. This approximate FQVT therefore only takes into account the energetically lowest excited states and thus requires significantly fewer parameters, which analogously reduces resource requirements and error susceptibility of the method. in particular for large systems, this modification can significantly reduce resource requirements (e.g., computing time) without significant loss of accuracy.

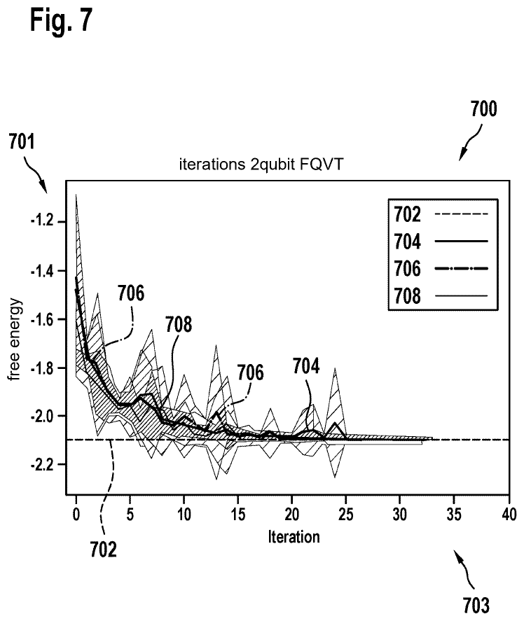

FIG. 7 illustrates the method according to various embodiments 700 in a schematic diagram, in which the output 701 of the target function (here, for example, the free energy) is shown as a function of the run counter 703. Line 706 represents the method described herein in comparison to the theoretical value (line 702), to the ideal course (line 704), with which the probabilities of each state are calculated exactly, and to the FakeVigo simulator (line 708), which uses an error model derived from IBM's real quantum chip “Vigo.” The solid lines indicate the average of the respective test series and the flat areas indicate the error interval given by the standard deviation.

In a first working example, the method (e.g., each optimization process sequence) comprises carrying out the first read-out process and/or the second read-out process at least 100 times (e.g., at least 1,000 times, e.g., at least 10,000 times, e.g., at least 30,000 times). In the first or a second working example, the output 701 of the target function was ascertained by means of a limited memory BFGS algorithm (L_BFGS_B) of qiskit as the optimization algorithm, wherein the Hamiltonian according to relation (3) and the operating sequence 106 according to embodiments 500 with β=1 were used. In the second or a third working example, the method according to embodiments 600 was carried out at least 20 times, wherein the parameter vector (\vec{ϕ}, \vec{θ}) was initialized by means of a random generator 601. All runs that achieved a free energy of less than −2.05 were counted as converged and in all cases accounted for at least 50% of all calculations.

In a fourth working example, the method explained herein (e.g., its FQVT) is used in order to solve a so-called quantum impurity problem. Within the scope of the so-called dynamical mean-field-theory (DMFT), properties of materials with strongly correlated electrons can be calculated. These include materials that, for example, contain an element with d or f electrons and/or have potential for use in superconductors, electrolysis, batteries, (quantum) sensors, or fuel cells. In a fifth or the second working example, the optimization algorithm was configured to process as input the gradient dF/d(\vec{ϕ}, \vec{θ}), e.g., the gradients dF/dϕ and dF/dθ. Accordingly, the adjustment 213 can comprise ascertaining the gradient dF/d(\vec{ϕ}, \vec{θ}), for example by means of a parameter shift rule.

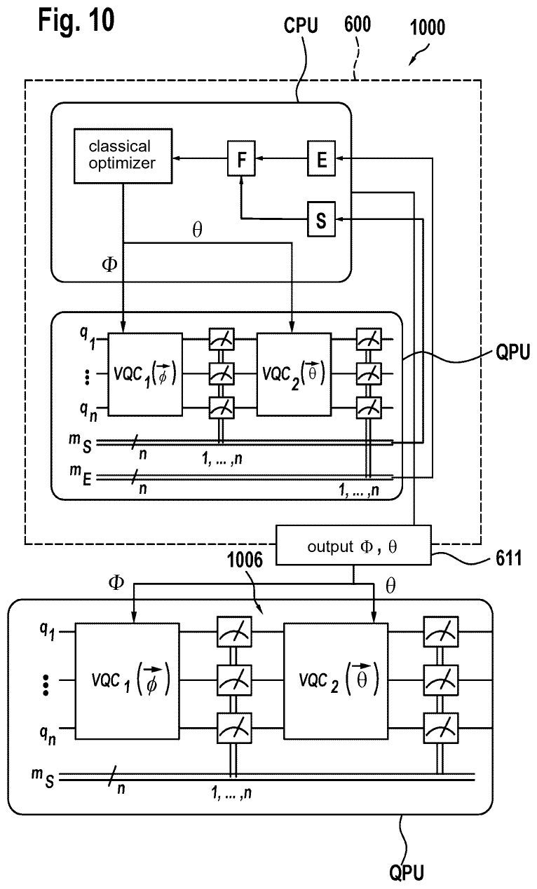

FIG. 10 illustrates the method according to various embodiments 1000 in a schematic diagram, which can be carried out for example by means of a control device 202, here, for example, designed as a CPU, for example based on a variation principle (e.g., the Rayleigh-Ritz principle). The method can be configured according to one or more than one of embodiments 100 to 900, for example at least according to embodiments 600 (also referred to as FQVT optimization 600). QR 102 can be controlled according to the output vector (\vec{ϕ}, \vec{θ})ₒᵤₜₚᵤₜ output by FQVT optimization 600, for example by means of an additional operating sequence 1006 (also referred to as the evaluation sequence 1006). The evaluation sequence 1006 can be configured like the operating sequence 106 described herein (e.g., configured according to embodiments 400a or embodiments 400b), for example with the difference that the evaluation sequence 1006 comprises more quantum gates than operating sequence 1006. This clearly results in the calculated thermal state being prepared on the QPU. For example, the evaluation sequence 1006 and operating sequence 106 of the FQVT optimization 600 can coincide in at least one or more than one (e.g., each) VQC, e.g., in VQC₁ and/or VQC₂. The evaluation sequence 1006 can comprise carrying out, between VQC₂ and the second read-out process (not shown) of the evaluation sequence 1006, at least one process (also referred to as operation process) of interaction with QR 102 or within QR 102 or between QR 102 and an additional QR. Examples of the operation process include: control in accordance with a quantum gate (also referred to as third control) and/or carrying out of a read-out process. This makes it possible to ascertain one or more than one physical variable of the QS (for example, occupation numbers or Green's functions) in the thermal state. For example, the evaluation sequence 1006 no longer needs to be followed by an adjustment process 213.

Although specific embodiments have been depicted and described herein, a person skilled in the art will recognize that the specific embodiments shown and described may be replaced with a variety of alternative and/or equivalent implementations without departing from the scope of protection of the present invention. This application is intended to cover any adaptations or variations of the specific embodiments discussed herein.

1-10. (canceled)

11. A method for operating a quantum register, comprising the following steps:
carrying out of a first read-out process, so that first data representing a first state of the quantum register are ascertained;
carrying out a first control of the quantum register, which is in the first state, in accordance with at least one quantum gate;
carrying out of a second read-out process, so that second data representing a second state of the quantum register which results from the first control are ascertained;
adjusting at least one parameter of the at least one quantum gate using the first data and the second data or optimizing a target function which is dependent on the first data and on the second data; and
carrying out a second control of the quantum register in accordance with the at least one quantum gate, which results from the adjusting.

12. The method according to claim 11, wherein the first read-out process includes:
reading out the quantum register; or
reading out an additional quantum register entangled with the quantum register.

13. The method according to claim 11, further comprising:
carrying out an additional first control of the quantum register in accordance with at least one additional quantum gate, wherein the first state of the quantum register is based on the additional control; and
wherein the adjusting includes adjusting or setting invariant at least one parameter of the at least one additional quantum gate using the first data and the second data;
carrying out an additional second control of the quantum register in accordance with the at least one additional quantum gate, which results from the adjustment.

14. The method according to claim 13, wherein according to the additional at least one quantum gate fewer qubits of the quantum register are controlled than according to the at least one quantum gate.

15. The method according to claim 13, wherein the at least one quantum gate and/or the at least one additional quantum gate are configured to bring the quantum register into an unentangled superposition state or an at least partially entangled superposition state.

16. The method according to claim 11, wherein the target function represents a physical state variable that is minimized.

17. The method according to claim 11, wherein the adjusting is based on an output of the target function that depends on the first data and second data and/or is minimized.

18. A control device configured to operate a quantum register, the control device configured to:
carry out of a first read-out process, so that first data representing a first state of the quantum register are ascertained;
carry out a first control of the quantum register, which is in the first state, in accordance with at least one quantum gate;
carry out of a second read-out process, so that second data representing a second state of the quantum register which results from the first control are ascertained;
adjust at least one parameter of the at least one quantum gate using the first data and the second data or optimizing a target function which is dependent on the first data and on the second data; and
carrying out a second control of the quantum register in accordance with the at least one quantum gate, which results from the adjusting.

19. A non-transitory computer-readable medium on which are stored instructions for operating a quantum register, the instructions, when executed by a processor, causing the processor to perform the following steps:
carrying out of a first read-out process, so that first data representing a first state of the quantum register are ascertained;
carrying out a first control of the quantum register, which is in the first state, in accordance with at least one quantum gate;
carrying out of a second read-out process, so that second data representing a second state of the quantum register which results from the first control are ascertained;
adjusting at least one parameter of the at least one quantum gate using the first data and the second data or optimizing a target function which is dependent on the first data and on the second data; and
carrying out a second control of the quantum register in accordance with the at least one quantum gate, which results from the adjusting.
